(19) United States
(12) Patent Application Publication
(10) Pub. No.: US 2008/0098434 A1
(43) Pub. Date: Apr. 24, 2008

(54) DIGITAL BROADCASTING RECEIVING DEVICE AND METHOD FOR AUDIBLY INFORMING OF CHANNEL CHANGE

(75) Inventor: Hai Min LEE, Hwaseong-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD, Suwon-si (KR)

(21) Appl. No.: 11/871,607

(22) Filed: Oct. 12, 2007

(30) Foreign Application Priority Data
Oct. 24, 2006 (KR) 2006-0103428

(51) Int. Cl. H04N 5/44; G06F 3/01

(52) U.S. Cl. 725/56; 715/716

(57) ABSTRACT

Provided are a digital broadcasting receiving device and method for audibly informing a user of a channel change. The method includes searching for channel information and channel audio guide signal premapped to the channel information, upon sensing a channel change, selecting a channel audio guide signal corresponding to the channel information, if channel information about a changed channel exists, and outputting the selected channel audio guide signal through an audio output unit. Thus, the method is capable of informing a user of a channel change by outputting a channel audio guide signal, allowing the user to audibly check a changed channel.

### PRIORITY

This application claims priority to an application entitled “DIGITAL BROADCASTING RECEIVING DEVICE AND METHOD FOR INFORMING OF CHANNEL CHANGE AUDIBLY” filed in the Korean Intellectual Property Office on Oct. 24, 2006 and assigned Serial No. 2006-0103428, the contents of which are incorporated herein by reference.

### BACKGROUND OF THE INVENTION

1. Field of the Invention

The present invention relates to a digital broadcasting receiving device, and more particularly, to a digital broadcasting receiving device and method for audibly informing a user of a channel change.

2. Description of the Related Art

The recent high penetration of mobile terminals has led to increasing demands for mobile terminals with more diverse functions. To cope with this trend, mobile terminal manufacturers provide diverse functions in addition to the basic functions of mobile terminals, thus improving user convenience.

For example, a Digital Multimedia Broadcasting (DMB) phone capable of receiving digital broadcasting receives broadcast signals and program guide data to output a program corresponding to the received broadcast signal through a screen. The program guide data is provided formatted as text.

The program guide data is displayed according to user selection and includes the title and broadcast time of a program currently being broadcast. However, because program guide data is typically displayed on the full screen, a user cannot view the program guide data while simultaneously watching a program being broadcast.

A proposed approach to solving the above problems is to display brief information about a program such as channel information and program title at the bottom of the screen. However, this approach has a drawback in that it is difficult to check information about a changed channel when a user changes the channel without viewing the screen. For example, if a user desires to change a channel while driving, their eyes cannot concentrate on a DMB phone because they must concentrate on driving. Thus, when a channel change occurs, it is difficult to check information about a new channel. Another drawback is that it is inconvenient to change a channel while driving because the user's eyes must focus on the DMB phone when searching for a plurality of broadcast channels.

### SUMMARY OF THE INVENTION

In order to solve the above problems, an object of the present invention is to provide a method for informing a user of a channel change in a digital broadcasting device without the user having to watch a screen.

Another object of the present invention is to provide a method for audibly informing a user of a channel change in a digital broadcasting device.

In order to achieve the above objects, according to an exemplary embodiment of the present invention, there is provided a digital broadcasting receiving device capable of audibly informing a channel change, including a storage unit for storing channel information and channel audio guide signals corresponding to the stored channel information; a digital broadcasting receiver for receiving a broadcast signal containing channel information; a searching portion for finding channel information among the stored channel information that is identical to the channel information contained in a broadcast signal of a changed channel, upon sensing a channel change signal for changing a channel, and for selecting the channel audio guide signal corresponding to the found channel information; and an audio output unit for outputting the selected channel audio guide signal.

In another exemplary embodiment of the present invention, a digital broadcasting receiving device capable of audibly informing a user of a channel change includes a digital broadcasting receiver for receiving a broadcast signal and program guide data; an audio signal generator for generating channel audio guide signals corresponding to channel information contained in the received program guide data; a searching portion for finding channel information identical to channel information about a channel corresponding to the channel change signal among the channel information contained in the program guide data, upon sensing a channel change signal for changing a channel, and for selecting the channel audio guide signal corresponding to the found channel information; and an audio output unit for outputting the selected channel audio guide signal.

In accordance with the present invention, there is provided a method for audibly informing of a channel change in a digital broadcasting receiving device, the digital broadcasting receiving device having stored channel information and channel audio guide signals corresponding to the channel information, the method includes sensing a channel change signal for changing a channel, upon receipt of a broadcast signal containing channel information; finding channel information among the stored channel information that is identical to channel information about a channel corresponding to the channel change signal, and selecting the channel audio guide signal corresponding to the found channel information; and outputting the selected channel audio guide signal.

In another exemplary embodiment of the present invention, a method for audibly informing of a channel change in a digital broadcasting receiving device capable of receiving program guide data includes generating and storing channel audio guide signals corresponding to channel information contained in the received program guide data; sensing a channel change signal for changing a channel; finding channel information among the stored channel information identical to channel information about a channel corresponding to the channel change signal, and selecting the channel audio guide signal corresponding to the found channel information; and outputting the selected channel audio guide signal.

### BRIEF DESCRIPTION OF THE DRAWINGS

The above and other objects, features and advantages of the present invention will be more apparent from the following detailed description in conjunction with the accompanying drawings, in which:

FIG. 1 is a block diagram of a digital broadcasting receiving device for audibly informing of a channel change according to the present invention;

FIG. 2 is a flowchart of a method for audibly informing of a channel change in a digital broadcasting receiving device according to the present invention;

FIG. 3 is a detailed flowchart of an operation of outputting a channel audio guide signal according to the method of FIG. 2;

FIG. 4 is a block diagram of a digital broadcasting receiving device for audibly informing of a channel change according to the present invention; and

FIG. 5 is a flowchart of a method for audibly informing of a channel change in a digital broadcasting receiving device according to the present invention.

### DETAILED DESCRIPTION OF PREFERRED EMBODIMENTS

Exemplary embodiments of the present invention are described in detail with reference to the accompanying drawings. The same reference numbers are used throughout the drawings to refer to the same or like parts. Detailed descriptions of constructions or processes known in the art may be omitted to avoid obscuring the subject matter of the present invention.

Particular terms used in the specification and claims are defined as follows.

1. “Channel information” contains at least one of a channel number and channel providing broadcasting company. A channel number (for example, ‘11’, ‘7’, or ‘9’) identifies a specific number entered by a user for viewing the channel. A channel providing broadcasting company (for example, ‘ABC’ or ‘BBC’) refers to a business entity providing a broadcasting service to a specific channel.

2. A “channel audio guide signal” refers to a signal generated by converting channel information into an audio signal, or to a prestored audio signal corresponding to channel information.

3. A “channel change signal” is a signal input by a user to change a channel.

4. “Program guide data” refers to Electronic Program Guide (EPG) data that is provided simultaneously with a broadcast signal. For example, the program guide data may include channel information, broadcast time, program title, and other data.

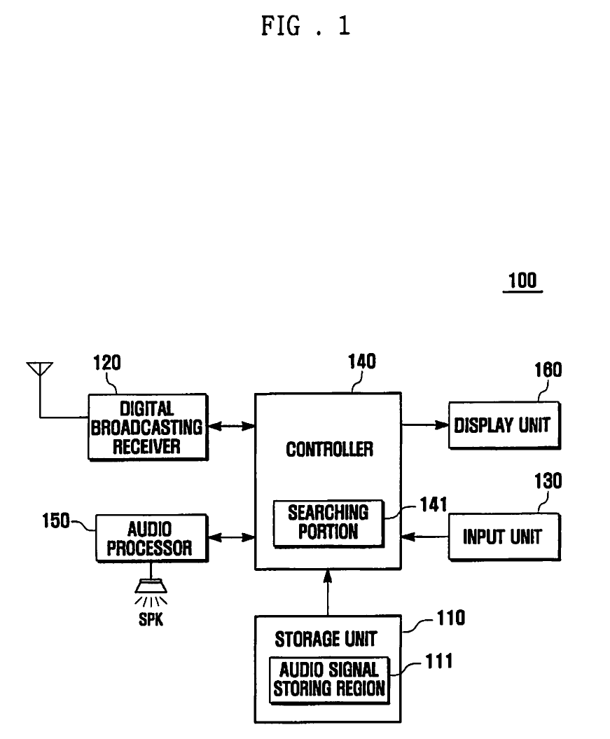

Referring to FIG. 1, digital broadcasting receiving device 100 includes a storage unit 110, a digital broadcasting receiver 120, an input unit 130, a controller 140, an audio processor 150, and a display unit 160.

Storage unit 110 stores programs and data necessary to support operation of controller 140 of digital broadcasting receiving device 100. Storage unit 110 may be an Erasable Programmable Read Only Memory (EPROM), Static Random Access Memory (SRAM), Flash memory, or various other types of memory. In particular, storage unit 110 includes an audio signal storing region 111. Audio signal storing region 111 stores channel information and channel audio guide signals mapped to the channel information during manufacturing of digital broadcasting receiving device 100. Table 1 illustrates an example of channel information and corresponding mapped channel audio guide signals.

TABLE 1

| Channel providing | Channel | Channel Audio |
|---|---|---|
| Broadcasting Company | Number | Guide Signal |
| AAA | 1 | Channel audio |
| | | guide signal 1 |
| BBB | 2 | Channel audio |
| | | guide signal 2 |
| CCC | 3 | Channel audio |
| | | guide signal 3 |

As illustrated in Table 1, audio signal storing region 111 stores the channel providing broadcasting company ‘AAA’ and channel number ‘1’, and ‘channel audio guide signal 1’ mapped to at least one of the channel providing broadcasting company ‘AAA’ and channel number ‘1’. That is, the ‘channel audio guide signal 1’ is an audio signal mapped to either of the channel providing broadcasting company ‘AAA’ or channel number ‘1’. Meanwhile, in case of informing of a channel providing broadcasting company and a channel number at the same time, the ‘channel audio guide signal 1’ may be a combination of audio signals corresponding to the channel providing broadcasting company ‘AAA’ and the channel number ‘1’.

Digital broadcasting receiver 120 receives a broadcast signal containing channel information and separates the received broadcast signal into audio and video signals. Digital broadcasting receiver 120 outputs the separate audio and video signals to controller 140.

Input unit 130 acts as a user interface and may be a keypad, touch screen, or other types of input devices. Input unit 130 outputs a control signal input by the user to controller 140. That is, input unit 130 outputs a control signal input by the user, which is then processed by controller 130 to perform an operation in response thereto. In particular, input unit 130 outputs a channel change signal generated according to user selection information to controller 140.

For example, upon receiving a broadcast signal from digital broadcasting receiver 120, input unit 130 generates a channel change signal according to arrow keys (up/down/left/right) input by the user. Alternatively, input unit 130 may receive an input from numeric keys corresponding to channel numbers such as ‘1’, ‘2’, and ‘3’ from the user to generate a channel change signal. It is also possible to generate a channel change signal according to a side key input by the user.

Controller 140 controls the overall state and operation of digital broadcasting receiving device 100. Controller 140 may be a microprocessor or digital signal processor (DSP). Controller 140 also outputs an audio signal received from digital broadcasting receiver 120 to audio processor 150 and decodes a video signal into a Moving Pictures Experts Group (MPEG) signal to output the MPEG signal to display unit 160. In particular, controller 140 extracts channel information contained in the broadcast signal received from digital broadcasting receiver 120.

Controller 140 includes a searching portion 141. Searching portion 141 senses a channel change signal input from input unit 130 to find channel information that is identical to the channel information contained in a broadcast signal of a changed channel among channel information stored in storage unit 110. Searching portion 141 selects a channel audio guide signal corresponding to the found channel information and outputs the channel audio guide signal to audio processor 150.

Audio processor 150 processes an audio signal input through digital broadcasting receiver 120 into a form that can be output through a speaker SPK. In particular, audio processor 150 is controlled by controller 140 to output the selected channel audio guide signal through the speaker SPK.

Display unit 160 displays the state and operation of digital broadcasting receiving device 100. Display unit 160 is also controlled by controller 130 to receive and display data corresponding to a control signal input through input unit 130 or to display the operational state of digital broadcasting receiving device 100 and various types of information using icons and characters. Further, display unit 160 is controlled by controller 130 to visually notify a user of a state in which a necessary function has been set or performed. In particular, display unit 160 displays a video signal contained in the broadcast signal received from digital broadcasting receiver 120 under the control of controller 140. The digital broadcasting receiving device 100 has channel information and channel audio guide signals corresponding to the channel information prestored therein.

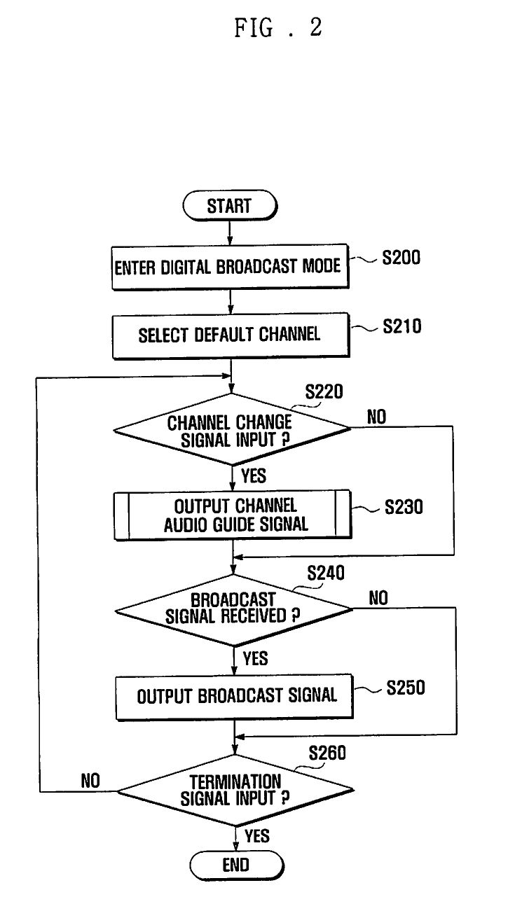

Referring to FIGS. 1 and 2, when digital broadcasting device 100 enters a digital broadcast mode in step S200, controller 140 selects a default channel for receiving a broadcast signal in step S210. Preferably, the default channel is the last channel through which a broadcast signal was received in the previous digital broadcast mode. Alternatively, the default channel may be set to a specific channel selected according to user selection information.

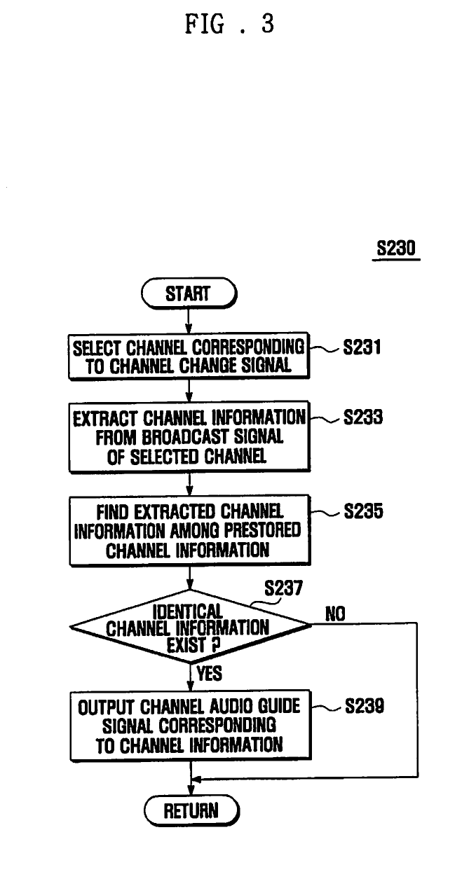

Controller 140 checks if a channel change signal is input in step S220. The channel change signal is input using one of arrow keys (up/down/left/right) input according to user selection information, numeric keys corresponding to channel numbers, or side keys. If a channel change signal is input, controller 140 outputs a channel audio guide signal corresponding to a changed channel in step S230. The operation of outputting a channel audio guide signal at step S230 is illustrated in detail in FIG. 3 as follows.

Referring to FIGS. 1 and 3, controller 140 selects a channel in response to the input channel change signal in step S231. Controller 140 controls digital broadcasting receiver 120 to receive a broadcast signal of the selected channel and to extract channel information from the received broadcast signal in step S233. Controller 140 controls searching portion 141 to search storage unit 110 for prestored channel information that is identical to the extracted channel information and to output the search result in step S235. Controller 140 checks if channel information identical to the extracted channel information exists in storage unit 110 in step S237. If identical channel information exists in storage unit 110, controller 140 controls searching portion 141 to select a channel audio guide signal corresponding to the channel information and to output the channel audio guide signal to audio processor 150, and then controls audio processor 150 to output the channel audio guide signal in step S239. Thus, upon sensing a change of a channel from the broadcast signal received from digital broadcasting receiving device 100, information about a changed channel is output in the form of an audio signal, thus allowing the user to be informed of a changed channel without having to visually check it.

Conversely, if identical channel information does not exist in storage unit 110 at step S237, controller 140 does not output a channel audio guide signal. In this case, controller 140 may instead output a warning sound or guiding phrase informing the user that identical channel information does not exist.

Returning to FIG. 2, controller 140 controls digital broadcasting receiver 120 to check if a broadcast signal is received in step S240. If a broadcast signal is received, controller 140 controls the digital broadcasting receiver 120 to output the received broadcast signal in step S250. More specifically, controller 140 controls the digital broadcasting receiver 120 to separate the received broadcast signal into audio and video signals. In this case, digital broadcasting receiver 120 outputs the audio signal to audio processor 150 while decoding the video signal into an MPEG signal to output the MPEG signal to display unit 160. Controller 140 then controls display unit 160 to output the video signal of the broadcast signal, and controls audio processor 150 to output the audio signal through the speaker SPK.

Controller 140 checks whether a termination signal is input in step S260. If a termination signal is input, controller 140 terminates the digital broadcast mode. If a termination signal is not input, the process returns to step S220.

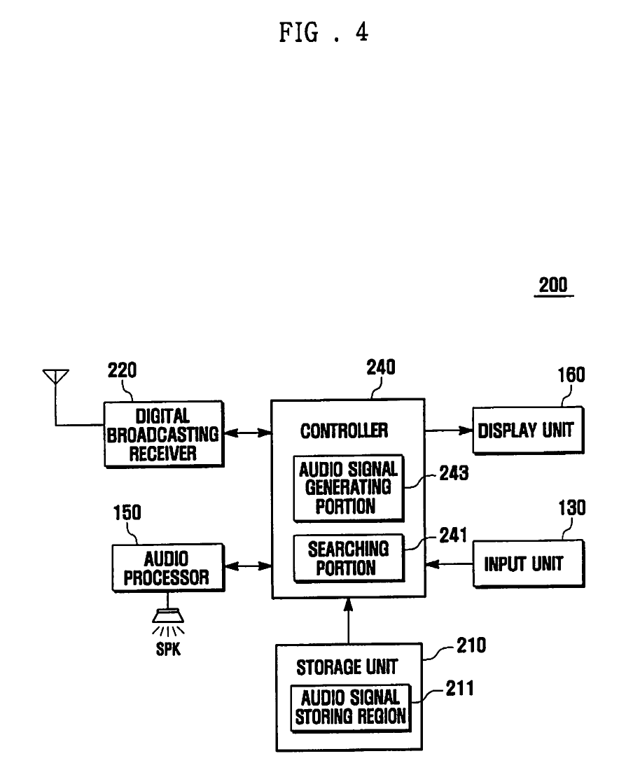

Referring to FIG. 4, digital broadcasting receiving device 200 according to the present invention includes a digital broadcasting receiver 220, a controller 240, a storage unit 210, an input unit 130, an audio processor 150, and a display unit 160.

Digital broadcasting receiver 220 performs similar functions to digital broadcasting receiver 120 of FIG. 1 except that digital broadcasting receiver 220 receives program guide data in addition to a broadcast signal.

Controller 240 controls the overall state and operation of digital broadcasting receiving device 200. In particular, controller 240 extracts channel information contained in the broadcast signal received from digital broadcasting receiver 220. Controller 240 includes an audio signal generating portion 243 and a searching portion 241.

More specifically, audio signal generating portion 243 extracts channel information contained in the program guide data received from digital broadcasting receiver 220. Audio signal generating portion 243 also generates a channel audio guide signal corresponding to the extracted channel information. That is, audio signal generating portion 243 converts the channel information into an audio signal to generate the channel audio guide signal. For example, if channel providing broadcasting company ‘AAA’ and channel number ‘1’ are extracted from the program guide data as illustrated in Table 1, audio signal generating portion 243 converts the channel providing broadcasting company ‘AAA’ and channel number ‘1’ into a channel audio guide signal to generate ‘channel audio guide signal 1’. The ‘channel audio guide signal 1’ may be generated by converting either of the channel providing broadcasting company ‘AAA’ and channel number ‘1’ into an audio signal. Alternatively, the ‘channel audio guide signal 1’ may be a combination of audio signals generated by converting the channel providing broadcasting company ‘AAA’ and channel number ‘1’.

Audio signal generating portion 243 also maps the channel audio guide signal onto its corresponding channel information and outputs the result to storage unit 210 for storage.

When sensing a channel change signal input from input unit 130, searching portion 241 finds channel information that is identical to a broadcast signal of a changed channel among channel information stored in storage unit 210. Searching portion 241 also selects a channel audio guide signal corresponding to the found channel information to output the channel audio guide signal to audio processor 150.

Storage unit 210 performs similar functions to storage unit 110 of FIG. 1. In particular, storage unit 210 stores program guide data received from digital broadcasting receiver 220. Storage unit 210 includes audio signal storing region 211. Audio signal storing region 211 stores the channel audio guide signal and its mapped channel information output from audio signal generating portion 243.

As illustrated in Table 1, audio signal storing region 211 stores the channel providing broadcasting company ‘AAA’ and channel number ‘1’, and the ‘channel audio guide signal 1’ that is generated by audio signal generating portion 243 and mapped to the channel providing broadcasting company ‘AAA’ and channel number ‘1’.

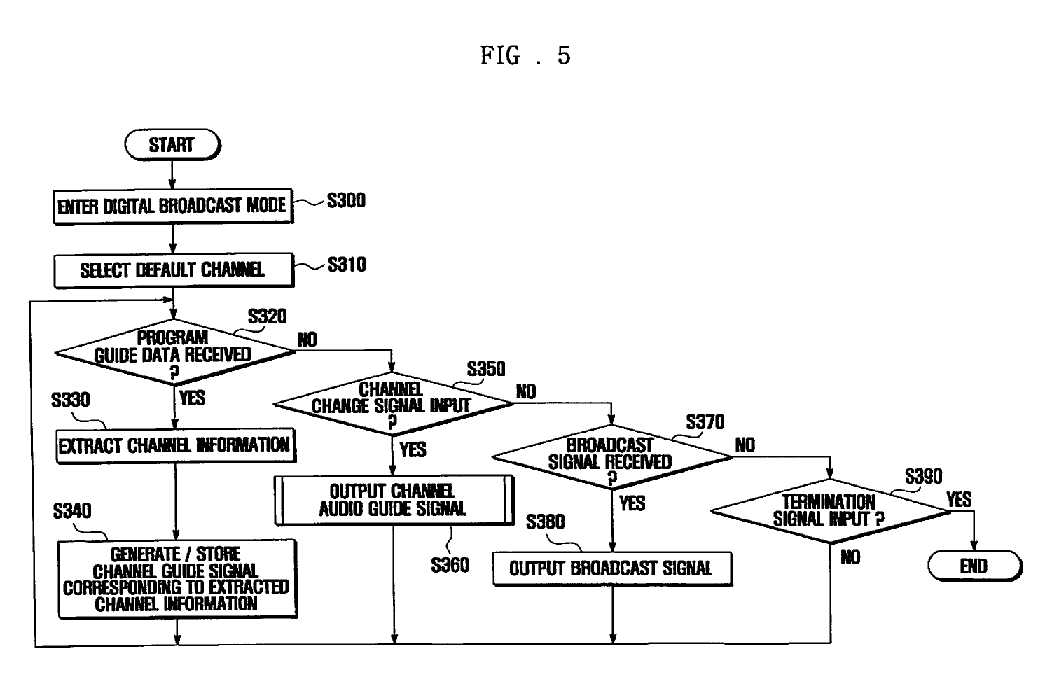

Referring to FIGS. 4 and 5, when the digital broadcasting device 200 enters a digital broadcast mode in step S300, controller 240 selects a default channel for receiving a broadcast signal in step S310. Preferably, the default channel is the last channel through which a broadcast signal was received in the previous digital broadcast mode. Alternatively, the default channel may be set to a specific channel selected according to user selection information.

Controller 240 checks whether program guide data is received in step S320. If the program guide data is received, controller 240 analyzes the program guide data to extract channel information in step S330. After extracting the channel information, controller 240 controls audio signal generating portion 243 to generate a channel audio guide signal corresponding to the extracted channel information in step S340. That is, audio signal generating portion 243 converts the extracted channel information into an audio signal to generate a channel audio guide signal. In this case, audio signal generating portion 243 maps the generated channel audio guide signal to its corresponding channel information and outputs the mapping result to storage unit 210 for storage.

If the program guide data is not input at step S320, controller 240 checks whether a channel change signal is input in step S350. If a channel change signal is input, controller 240 outputs a channel audio guide signal corresponding to a changed channel in step S360. The channel change signal is input using one of arrow keys (up/down/left/right) input according to user selection information, numeric keys corresponding to channel numbers, or side keys. Step S360 is similar to step S230 of the embodiment of FIG. 2, which was illustrated in detail in FIG. 3. In particular, in step S360, as illustrated by step S230 of FIG. 3, the channel information stored in storage unit 210 is acquired from the program guide data received from digital broadcasting receiver 220.

If a channel change signal is not input at step S350, controller 240 controls the digital broadcasting receiver 220 to check whether a broadcast signal is received at step S370. If a broadcast signal is received, controller 240 controls digital broadcasting receiver 220 to output the received broadcast signal in step S380. More specifically, controller 240 controls digital broadcasting receiver 220 to separate the received broadcast signal into audio and video signals. In this case, digital broadcasting receiver 220 outputs the audio signal to audio processor 150 while decoding the video signal into an MPEG signal to output the MPEG signal to display unit 160. Controller 240 then controls display unit 160 to output the video signal of the broadcast signal, and controls audio processor 150 to output the audio signal through speaker SPK.

Conversely, if the broadcast signal is not received at step S370, controller 240 checks if a termination signal is input as step S390. If a termination signal is input, controller 240 terminates the digital broadcast mode. If a termination signal is not input, the process returns to step S320.

Described above is a digital broadcasting receiving device and method for audibly informing of a channel change according to the present invention to allow information about a changed receiving channel to be output in the form of an audio signal, thus enabling a user to be informed of a changed channel without having to visually check the changed channel. For example, if a channel change occurs during driving, the user can easily be informed of a changed channel without reducing concentration on driving.

While the present invention has been particularly shown and described with reference to embodiments thereof, it will be understood by those of ordinary skill in the art that various changes in form and details may be made therein without departing from the spirit and scope of the present invention as further defined by the following claims.

What is claimed is:

1. A digital broadcasting receiving device capable of audibly informing of a channel change, comprising:
a storage unit for storing channel information and channel audio guide signals corresponding to a stored channel information;
a digital broadcasting receiver for receiving a broadcast signal containing channel information;
a searching portion for finding channel information among the stored channel information that is identical to the channel information contained in a broadcast signal of a changed channel, upon sensing a channel change signal, and for selecting the channel audio guide signal corresponding to the found channel information; and
an audio output unit for outputting the selected channel audio guide signal.

2. The device of claim 1, further comprising an input unit for generating the channel change signal.

3. The device of claim 2, wherein the input unit generates the channel change signal in response to an input from arrow keys, side keys, or numeric keys.

4. The device of claim 1, wherein the channel information contains at least one of channel number and channel providing broadcasting company.

5. The device of claim 4, wherein the channel audio guide signal is at least one of audio signals corresponding to the channel number and the channel providing broadcasting company.

6. A digital broadcasting receiving device capable of audibly informing of a channel change, comprising:
a digital broadcasting receiver for receiving a broadcast signal and program guide data;
an audio signal generator for generating channel audio guide signals corresponding to channel information contained in the received program guide data;
a searching portion for finding channel information identical to channel information about a channel corresponding to the channel change signal among the channel information contained in the program guide data, upon sensing a channel change signal, and for selecting the channel audio guide signal corresponding to the found channel information; and
an audio output unit for outputting the selected channel audio guide signal.

7. The device of claim 6, wherein the audio signal generator maps the channel audio guide signals onto corresponding channel information.

8. The device of claim 6, further comprising a storage unit for storing the channel information and the channel audio guide signals corresponding to the channel information.

9. The device of claim 6, further comprising an input unit for generating the channel change signal.

10. The device of claim 9, wherein the input unit generates the channel change signal in response to an input from arrow keys, side keys, or numeric keys.

11. The device of claim 6, wherein the channel information contains at least one of channel number and channel providing broadcasting company.

12. The device of claim 11, wherein the channel audio guide signal is at least one of audio signals corresponding to the channel number and the channel providing broadcasting company.

13. A method for audibly informing of a channel change in a digital broadcasting receiving device, the digital broadcasting receiving device having stored channel information and channel audio guide signals corresponding to the channel information, the method comprising:
sensing, upon receipt of a broadcast signal containing channel information, a channel change signal for changing a channel;
finding channel information among the stored channel information that is identical to channel information about a channel corresponding to the channel change signal, and selecting the channel audio guide signal corresponding to the found channel information; and
outputting the selected channel audio guide signal.

14. The method of claim 13, further comprising inputting the channel change signal.

15. The method of claim 14, wherein the channel change signal is generated in response to an input from arrow keys, side keys, or numeric keys.

16. The method of claim 13, wherein the channel information contains at least one of channel number and channel providing broadcasting company.

17. The method of claim 16, wherein the channel audio guide signal is at least one of audio signals corresponding to the channel number and the channel providing broadcasting company.

18. A method for audibly informing of a channel change in a digital broadcasting receiving device capable of receiving program guide data, comprising:
generating and storing channel audio guide signals corresponding to channel information contained in the received program guide data;
sensing a channel change signal for changing a channel;
finding channel information among the stored channel information identical to channel information about a channel corresponding to the channel change signal, and selecting the channel audio guide signal corresponding to the found channel information; and
outputting the selected channel audio guide signal.

19. The method of claim 18, wherein channel audio guide signals generated corresponding to the channel information are stored together with the channel information.

20. The method of claim 18, further comprising inputting the channel change signal.

21. The method of claim 18, wherein the channel change signal is generated in response to an input from arrow keys, side keys, or numeric keys.

22. The method of claim 18, wherein the channel information contains at least one of channel number and channel providing broadcasting company.

23. The method of claim 22, wherein the channel audio guide signal is at least one of audio signals corresponding to the channel number and the channel providing broadcasting company.
